(19) United States
(12) Patent Application Publication
(10) Pub. No.: US 2019/0008191 A1
(43) Pub. Date: Jan. 10, 2019

(54) CAULIFLOWER PIZZA CRUST

(71) Applicant: Ittella International, Inc., Paramount, CA (US)

(72) Inventor: Sarah Galletti, Paramount, CA (US)

(73) Assignee: Ittella International, Inc., Paramount, CA (US)

(21) Appl. No.: 16/029,417

(22) Filed: Jul. 6, 2018

Related U.S. Application Data
(60) Provisional application No. 62/529,716, filed on Jul. 7, 2017.

(51) Int. Cl. A23L 19/00; A21D 2/26; A21D 2/36; A21D 13/41

(52) U.S. Cl. CPC A23L 19/09; A21D 2/262; A21D 2/263; A23V 2002/00; A21D 2/362; A21D 13/41; A21D 2/366

(57) ABSTRACT

A gluten-free cauliflower-based pizza dough and a preparation process for creating a cauliflower-based pizza crust are provided. The gluten-free cauliflower-based pizza dough comprises a quantity of pureed cauliflower. Egg whites and either shredded mozzarella cheese or parmesan cheese are mixed with the pureed cauliflower to form a mixture. Flour ingredients comprising potato flour, chickpea/garbanzo bean flour, brown rice flour are combined with the mixture. In a grain-free embodiment of the pizza dough, the flour ingredients are comprised of potato flour and chickpea/garbanzo bean flour. Seasoning ingredients are added to the mixture. Preferably, the season ingredients are Italian seasoning, including at least basil, oregano, rosemary, and thyme. Xanthan gum may be used as a thickening agent.

### PRIORITY

This application claims the benefit of and priority to U.S. Provisional Application, entitled “Cauliflower Pizza Crust,” filed on Jul. 7, 2017 and having application Ser. No. 62/529,716.

### FIELD

The field of the present disclosure generally relates to pizza. More particularly, the field of the invention relates to a cauliflower-based pizza crust and a preparation process for creating a cauliflower-based pizza crust.

### BACKGROUND

The conventional pizza pie comprises a dough base formed into a generally flat, circular or rectangular shell and covered with a sauce and a topping. Normally, the dough is a bread dough, the sauce is a tomato sauce, and the topping includes cheese and often also includes other foods such as pieces of pepperoni or anchovies. An outer edge crust is formed around the perimeter of the dough base to hold the sauce and the topping on the base as the pie is made. The pie is then baked in an oven, cut, and eaten.

Pizza is a widely popular food item in the United States and around the world. By combining ingredients from the various food groups, including bread, cheeses, meats and vegetables, pizza has become a quick, easy and nutritious meal that can be consumed at home, in restaurants or pizzerias, and on the go.

As shown in FIGS. 1-2, a typical pizza, generally designated 100, is comprised of a dough substrate 102 and one or more toppings 104 positioned over the dough substrate. The dough substrate 102 typically is formed into a generally flat sheet 106 having a crust portion 108 extending around a periphery of the sheet. As shown in FIG. 2, the crust portion 108 may be elevated relative to the sheet portion 106 so as to form a raised crust, similar to a traditional pie; hence the common reference to pizza as a “pizza pie.” The sheet portion 106 and the crust portion 108 define a surface or recess 120 for receiving the toppings 104. The assembled pizza 100 is typically baked before serving.

After baking, the pizza 100 typically is divided into a number of individual pieces 122A, 122B, 122C, 122D, 122E, 122F, 122G, 122H (collectively, “pieces 122”). The pieces 122 may be formed by cutting the pizza 100 into pie-shaped wedges, as shown in FIG. 1, or otherwise. Regardless of how the pizza 100 is cut, the amount of the crust portion 108 on each piece 122 is limited to the crust portion 108 along the original peripheral edge of the sheet portion 106 or, in some cases, depending on how the pizza was cut, may not have any exposed crust whatsoever.

The crust portion 108 of the pizza 100 is often the portion of the pizza that is most desired by certain consumers. Furthermore, the crust portion 108 of the pizza 100 often provides a useful function. For example, the crust portion 108 on a piece 122 of pizza 100 often is used by consumers to hold the piece of pizza without contacting the toppings 104. Furthermore, the crust portion 108, particularly a raised crust portion, provides a certain structural stability to the piece 122 of pizza 100, thereby making it easier to hold and consume.

As will be recognized, gluten is a protein composite found in wheat and related grains that are used in pizza dough. Gluten has historically been important in cooking because it gives elasticity to dough, helping it to rise and keep its shape, and can give the final product a chewy texture. However, in individuals with coeliac disease, an autoimmune disorder, consumption of gluten causes adverse health issues, including, but not limited to: abdominal bloating, gas, vomiting, diarrhea, migraines, and joint pain. While there is no known cure for coeliac disease, it is manageable with a gluten-free diet. Additionally, some people also have a wheat allergy and some people, for various medical reasons, follow a gluten-free diet.

Unfortunately, many gluten-free foods simply do not taste as good as their gluten counterparts. In gluten-free baking, people often complain about the taste resulting from the gluten substitute that is being used. In the absence of gluten, one needs some other binding agent, which oftentimes do not impart a pleasant taste into the food.

There is a need, therefore, for gluten-free foods that offer a pleasant taste. Accordingly, it would be desirable to provide a pizza having a crust that is comprised of a cauliflower-based pizza dough. Further, is would be desirable to provide a pizza, wherein the pizza is comprised of a grain-free cauliflower-based pizza crust.

### SUMMARY

A gluten-free cauliflower-based pizza crust and a preparation process for creating a cauliflower-based pizza crust are provided. The gluten-free cauliflower-based pizza dough comprises a quantity of pureed cauliflower. Egg whites and either shredded mozzarella cheese or parmesan cheese are mixed with the pureed cauliflower to form a mixture. Flour ingredients comprising potato flour, chickpea/garbanzo bean flour, brown rice flour are combined with the mixture. In a grain-free embodiment of the pizza dough, the flour ingredients are comprised of potato flour and chickpea/garbanzo bean flour. Seasoning ingredients are added to the mixture. Preferably, the season ingredients are Italian seasoning, including at least basil, oregano, rosemary, and thyme. Xanthan gum may be used as a thickening agent.

In an exemplary embodiment, a gluten-free cauliflower-based pizza dough for creating a cauliflower pizza crust comprises: a quantity of pureed cauliflower; one or more dairy ingredients mixed with the quantity of pureed cauliflower to form a mixture; one or more flour ingredients combined with the mixture; one or more seasoning ingredients added to the mixture; and one or more a thickening agent.

In another exemplary embodiment, the quantity of the pureed cauliflower comprises substantially 32.80%, by weight, of the pizza dough. In another exemplary embodiment, the one or more dairy ingredients are comprised of egg whites and shredded mozzarella cheese, the egg whites comprising substantially 6.00% of the pizza dough and the shredded mozzarella cheese comprising substantially 22.20% of the pizza dough. In another exemplary embodiment, the one or more dairy ingredients are comprised of egg whites, a portion of parmesan cheese, and a portion of mozzarella cheese.

In another exemplary embodiment, the one or more flour ingredients are comprised of potato flour, chickpea/garbanzo bean flour, brown rice flour. In another exemplary embodiment, the pizza dough is comprised of substantially 15.80% potato flour, 11.60% chickpea/garbanzo bean flour, and 11.27% brown rice flour. In another exemplary embodiment, the brown rice flour may be omitted, such that the pizza dough is grain-free and is comprised of 15.80% potato flour and 22.89% chickpea/garbanzo bean flour.

In another exemplary embodiment, the one or more seasoning ingredients are comprised of a quantity of Italian seasoning, the quantity comprising substantially 0.13%, by weight, of the pizza dough. In another exemplary embodiment, the Italian seasoning comprises at least any of roasted garlic, basil, oregano, rosemary, and thyme. In another exemplary embodiment, the one or more thickening agents comprises a quantity of xanthan gum and a portion of water to add texture to the pizza dough, the quantity comprising substantially 0.20%, by weight, of the pizza dough.

In an exemplary embodiment, a preparation process for a cauliflower-based pizza crust comprises: obtaining a quantity of pureed cauliflower; mixing one or more dairy ingredients with the quantity of pureed cauliflower to form a mixture; combining flour ingredients with the mixture; adding seasoning ingredients to the mixture; incorporating a thickening agent into the mixture to form a pizza dough; portioning the pizza dough into a plurality of portions; flattening each of the plurality of portions to form a sheet portion and a crust portion; and parbaking the plurality of portions.

In another exemplary embodiment, obtaining the pureed cauliflower comprises combining cauliflower with water or chicken stock, cooking until the cauliflower is very tender, and pureeing by way of a slotted spoon or a food processor. In another exemplary embodiment, the quantity of pureed cauliflower comprises substantially 32.80% of the pizza dough.

In another exemplary embodiment, the one or more dairy ingredients are comprised of egg whites and shredded mozzarella cheese. In another exemplary embodiment, parmesan cheese is used in place of a portion, or all the shredded mozzarella cheese. In another exemplary embodiment, the egg whites and the shredded mozzarella cheese respectively comprise 6.00% and 22.20% of the pizza dough.

In another exemplary embodiment, the flour ingredients are comprised of potato flour, chickpea/garbanzo bean flour, and brown rice flour, the potato flour comprising substantially 15.80% of the pizza dough, the chickpea/garbanzo bean flour comprising substantially 11.60% of the pizza dough, and the brown rice flour comprising substantially 11.27% of the pizza dough. In another exemplary embodiment, the flour ingredients are comprised of potato flour and chickpea/garbanzo bean flour, the potato flour comprising substantially 15.80% of the pizza dough, the chickpea/garbanzo bean flour comprising substantially 22.89% of the pizza dough.

In another exemplary embodiment, the seasoning ingredients comprise substantially 0.13%, by weight, of the pizza dough. In another exemplary embodiment, the seasoning ingredients are comprised of Italian seasoning. In another exemplary embodiment, the thickening agent is comprised of a quantity of xanthan gum, the quantity being substantially 0.20%, by weight, of the pizza dough.

In another exemplary embodiment, portioning comprises forming the plurality of portions such that each portion has a desired weight or size. In another exemplary embodiment, flattening comprises putting the plurality of portions onto a machine that flattens the portions, such that the each of the plurality of portions has a sheet portion and a peripheral crust portion. In another exemplary embodiment, flattening comprises a hand-flattening process whereby a practitioner manipulates each of the plurality of portions into a sheet portion and a peripheral crust portion.

In another exemplary embodiment, the preparation process further comprises adding one or more toppings to each of the plurality of portions and freezing for storage. In another exemplary embodiment, the preparation process further comprises adding one or more toppings to each of the plurality of portions and cooking to produce cooked cauliflower-based pizzas.

### BRIEF DESCRIPTION OF THE DRAWINGS

The drawings refer to embodiments of the present disclosure in which:

FIG. 1 illustrates a top plan view of a prior art pizza;

FIG. 2 illustrates a cross-sectional view of the pizza of FIG. 1, taken along line A-A;

FIG. 3 illustrates a list of ingredients comprising an exemplary embodiment of a gluten-free cauliflower-based pizza dough, according to the present disclosure; and

FIG. 4 is a flow chart illustrating an exemplary process for preparing a cauliflower-based pizza crust, according to the present disclosure.

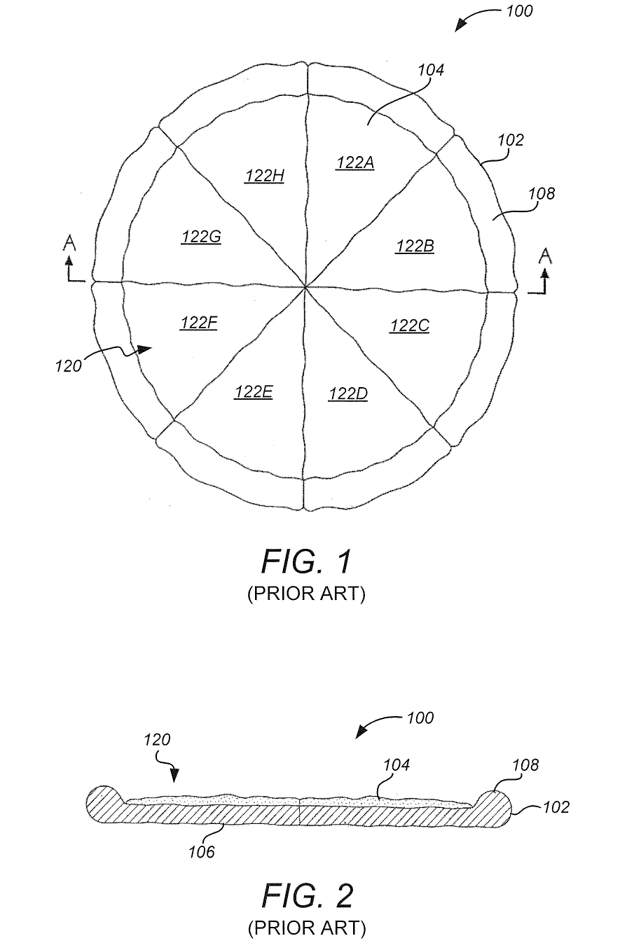

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first ingredient,” may be made. However, the specific numeric reference should not be interpreted as a literal sequential order but rather interpreted that the “first ingredient” is different than a “second ingredient.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, the present disclosure describes a gluten-free cauliflower-based pizza dough and a preparation process for the pizza dough that may be used to create a cauliflower-based pizza crust. The gluten-free cauliflower-based pizza dough comprises a quantity of pureed cauliflower. One or more dairy ingredients are mixed with the quantity of pureed cauliflower to form a mixture. The dairy products may be comprised of egg whites and either shredded mozzarella cheese or parmesan cheese. One or more flour ingredients are combined with the mixture. The flour ingredients may be comprised of potato flour, chickpea/garbanzo bean flour, brown rice flour. In a grain-free embodiment of the pizza dough, the flour ingredients are comprised of potato flour and chickpea/garbanzo bean flour. One or more seasoning ingredients are added to the mixture. Preferably, the season ingredients are comprised of a quantity of Italian seasoning, including at least basil, oregano, rosemary, and thyme. Xanthan gum may be used as a thickening agent.

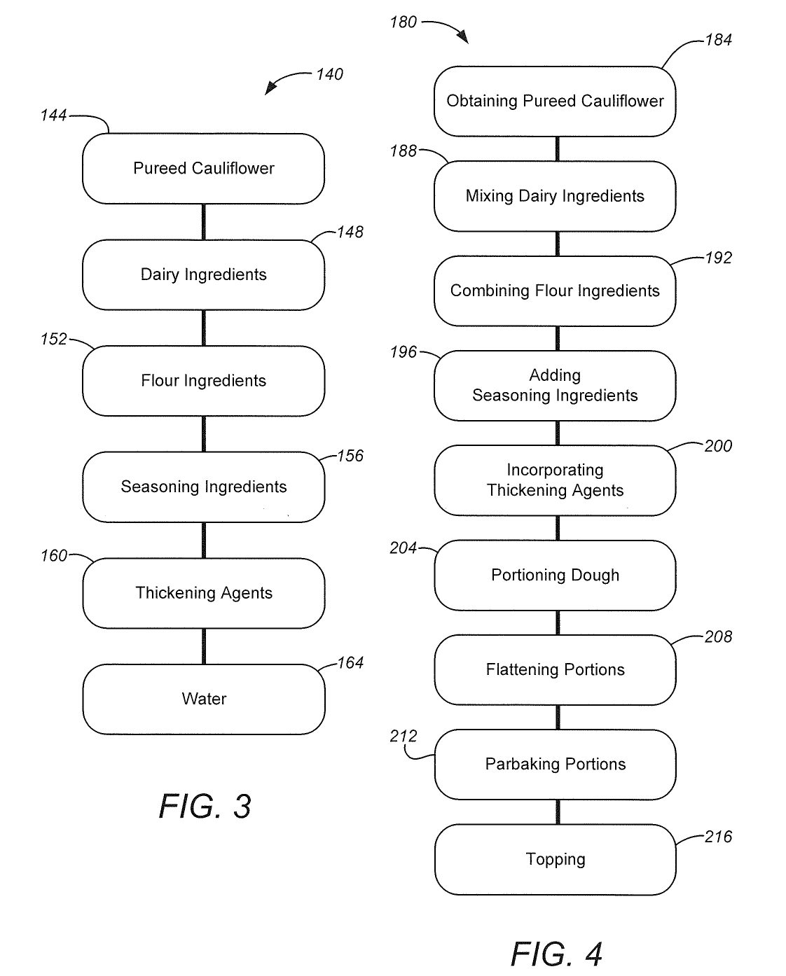

FIG. 3 illustrates a list of ingredients 140 comprising an exemplary embodiment of a gluten-free cauliflower-based pizza dough (hereinafter, “pizza dough 140”) that may be used to create a cauliflower-based pizza crust. The pizza dough 140 generally is comprised of pureed cauliflower 144, dairy ingredients 148, one or more flour ingredients 152, seasoning ingredients 156, one or more thickening agents 160, and water 164. In one exemplary embodiment, the pizza dough 140 comprises cauliflower, low-moisture mozzarella cheese, rice flour, tapioca starch, water, egg whites, modified rice starch, sugar, organic yeast, salt, cultured brown rice, garlic powder, Italian seasoning, xanthan gum. In one exemplary embodiment, the pureed cauliflower 144 comprises approximately 32.80%, by weight, of the pizza dough 140. The dairy ingredients 148 may be comprised of egg whites and shredded mozzarella cheese. The egg whites generally comprise 6.00%, and the shredded mozzarella cheese comprises 22.20% of the pizza dough 140. It is contemplated that the shredded mozzarella cheese is of a non-GMO lower-moisture, part-skim variety. In some embodiments, however, parmesan cheese may be used in place of a portion, or all the mozzarella cheese, as desired.

The flour ingredients 152 may be comprised of potato flour, chickpea/garbanzo bean flour, brown rice flour. In one exemplary gluten-free embodiment, the pizza dough 140 is comprised of approximately 15.80% potato flour, 11.60% chickpea/garbanzo bean flour, and 11.27% brown rice flour. In one exemplary grain-free embodiment, the brown rice flour may be omitted, such that the pizza dough 140 is comprised of 15.80% potato flour and 22.89% chickpea/garbanzo bean flour.

The seasoning ingredients 156 preferably are comprised of Italian seasoning, such that the Italian seasoning comprises approximately 0.13%, by weight, of the pizza dough 140. In some embodiments, the Italian seasoning may be comprised of a blend of ground spices such as, by way of non-limiting example, basil, oregano, rosemary, thyme, roasted garlic, garlic powder, sage, cilantro, and the like.

As disclosed above, one or more thickening agents 160 may be incorporated into the pizza dough 140. In some embodiments, the one or more thickening agents 160 may be comprised of xanthan gum. In one embodiment, the xanthan gum comprises approximately 0.20%, by weight, of the pizza dough 140. As will be recognized, xanthan gum is a polysaccharide having a wide variety of known uses, including being useful as a powerful thickening agent, and is useful as a stabilizer to prevent ingredients from separating. Further, the water 164 may be added, as desired, to add texture to the pizza dough 140.

FIG. 4 is a flow chart illustrating an exemplary preparation process 180 for a cauliflower-based pizza crust, according to the present disclosure. The preparation process 180 begins with a step 184 comprised of obtaining pureed cauliflower 144. It is contemplated that, in some embodiments, the pureed cauliflower 144 may be obtained by combining cauliflower with water or chicken stock, cooking until the cauliflower is very tender, and pureeing by way of a slotted spoon or a food processor. It should be understood, however, that the pureed cauliflower 144 may be obtained by way of various techniques or methods, without limitation.

As disclosed herein, the pureed cauliflower 144 preferably comprises approximately 32.80%, by weight, of the pizza dough 140. For example, a quantity of the pureed cauliflower 144 comprising 3.28 pounds (lbs.), or 92.9864 grams, may be utilized to produce approximately 10.00 lbs. of the pizza dough 140. Further, a quantity of approximately 700.00 lbs. of the pizza dough 140 may be produced by way of substantially 230 lbs. of pureed cauliflower 144.

Once a desired quantity of the pureed cauliflower 144 has been obtained, the dairy ingredients 148 may be mixed with the pureed cauliflower 144 at a step 188. In some embodiments of the pizza dough 140, the dairy ingredients 148 may be comprised of egg whites and shredded mozzarella cheese. As disclosed hereinabove, parmesan cheese may be used in place of a portion, or all the mozzarella cheese, as desired. Continuing with the above example of producing approximately 10.00 lbs. of the pizza dough 140, the dairy ingredients 148 may be comprised of substantially 0.6 lbs. (17.0097 grams) egg whites and substantially 2.22 lbs. (62.93589 grams) shredded mozzarella cheese. Further, to produce a quantity of approximately 700.00 lbs. of the pizza dough 140, substantially 42 lbs. of egg whites and substantially 155 lbs. of shredded mozzarella cheese may be mixed with the pureed cauliflower 144 during the step 188.

In a step 192, the flour ingredients 152 may be combined with the pureed cauliflower 144 and the dairy ingredients 148. In a gluten-free embodiment of the pizza dough 140, the flour ingredients 152 may be comprised of 111 lbs. of potato flour, 81 lbs. of chickpea/garbanzo bean flour 81 lbs., and 79 lbs. of brown rice flour to produce substantially 700.00 lbs. of the pizza dough 140. In a grain-free embodiment of the pizza dough 140, the flour ingredients 152 may be comprised of 1.58 lbs. (44.79221 grams) of potato flour and 2.29 lbs. (64.920355 grams) of chickpea/garbanzo bean flour to produce substantially 10.00 lbs. of the pizza dough 140.

In a step 196, the seasoning ingredients 156 may be added to the mixture comprised of the pureed cauliflower 144, the dairy ingredients 148, and the flour ingredients 152. As disclosed above, the seasoning ingredients 156 preferably are comprised of Italian seasoning, including a blend of at least basil, oregano, rosemary, thyme. In some embodiments, the seasoning ingredients 156 may be further comprised of garlic powder, sage, cilantro, and the like. The seasoning ingredients 156 comprise approximately 0.13%, by weight, of the pizza dough 140. Thus, 10.00 lbs. of the pizza dough 140 may be comprised of substantially 0.013 lbs. (0.3685435 grams) of seasoning ingredients 156, and 700.00 lbs. of the pizza dough 140 may be comprised of approximately 1.0 lb. of seasoning ingredients.

One or more thickening agents 160 may be incorporated into the mixture during a step 200. Further, water 164 may be added to add texture to the pizza dough 140, as deemed necessary. In some embodiments, the thickening agents 160 may be comprised of xanthan gum, as described herein. The xanthan gum typically comprises approximately 0.20%, by weight, of the pizza dough 140. As such, 10.00 lbs. of the pizza dough 140 may be produced by way of substantially 0.02 lbs. (0.56699 grams) of xanthan gum. Similarly, 700.00 lbs. of the pizza dough 140 may be comprised of approximately 1.4 lbs. of xanthan gum.

Once steps 184 through 196 have been performed, the mixture may be used to produce the desired quantity of the pizza dough 140. As will be appreciated, the pizza dough 140 generally is of a yeast-free variety, and thus there is no need to wait for the pizza dough to “rise” as is commonly done with conventional yeast-based pizza doughs. At a step 204, the pizza dough 140 may be advantageously portioned. It is contemplated that the pizza dough 140 may be divided into a plurality of portions having a desired weight and/or size. In step 208, the plurality of portions may be put onto a machine that flattens the portions, such that the portions, upon being baked, will have a sheet portion 106 and a crust portion 108. It is contemplated, however, that step 208 may be comprised of a hand-flattening process whereby a practitioner may manipulate each of the portions into a sheet portion 106 and a crust portion 108.

In a step 212, the flattened portions of pizza dough 140 comprised of the sheet and crust portions 106, 108 may be parbaked, as desired. As will be appreciated, parbaking is a cooking technique whereby the flattened portions of the pizza dough 140 may be partially baked and then rapidly frozen for storage. In general, the raw pizza dough 140 may be baked normally, but halted at about 80% of the normal cooking time, at which point the flattened portions of the pizza dough 140 may be rapidly cooled and frozen.

When the parbaked portion of the pizza dough 140 is desired to form a cooked cauliflower-based pizza, one or more toppings may be added to the sheet portion 106 of the pizza dough 140 in step 216. It is contemplated that the one or more toppings may be comprised of any of various sauces, meat toppings, and non-meat toppings. The sauces may include, but are not limited to alfredo sauce, BBQ sauce, blue cheese sauce, garlic parmesan white sauce, marinara sauce, hot sauce, mango habanero sauce, ranch dressing, robust inspired tomato sauce, tomato sauce, and the like. In some embodiments, the meat toppings may include, but are not limited to bacon, beef, ham, Italian sausage, pepperoni, Philly steak, premium chicken, salami, sliced Italian sausage, and the like. Further, in some embodiments, the non-meat toppings may include, but are not limited to low-moisture mozzarella cheese, American cheese, banana peppers, black olives, cheddar cheese, cheese, diced tomatoes, feta cheese, roasted zucchini, roasted green bell peppers, roasted yellow bell peppers, roasted red bell peppers, hot sauce, jalapeno peppers, mushrooms, roasted onions, pineapple, shredded parmesan, a pecorino Romano and parmesan cheese blend, shredded provolone cheese, sliced provolone, spinach, and the like. It is contemplated that the low-moisture mozzarella cheese is of a non-GMO part-skim variety. The parbaked portion of the pizza dough 140 and the selected toppings may be “finished off” by baking at normal temperatures until the cooked cauliflower-based pizza is desirably ready for consumption, as indicated by the crust portion 108 becoming lightly browned.

In some instances, a cooked pizza having a cauliflower-based pizza crust may be desired immediately, in lieu of parbaking the pizza dough 140 in step 212. It is contemplated that after manipulating the pizza dough 140 into the sheet and crust portions 106, 108 in step 208, the practitioner may transfer the flattened pizza dough 140 onto a preheated baking stone, baking sheet, or an equivalent baking surface. In some embodiments, the baking surface may be comprised of a pizza stone, a steel sheet, or adequately sized quarry tiles, as desired. Preferably, the baking stone has been sufficiently preheated in an oven at a temperature ranging between about 500-550° F. In step 212, the portion of pizza dough 140 comprising the sheet and crust portions 106, 108 may be baked for about 10 minutes before the one or more toppings are placed onto the sheet portion 106 in step 216. Next, the portion of pizza dough 140 comprising the sheet and crust portions 106, 108, as well as the selected toppings may be “finished off” by baking an additional 7-10 minutes until the crust portion 108 becomes lightly browned. As a final step, the cooked cauliflower-based pizza may be placed onto a rack and allowed to cool slightly. Once the cauliflower-based pizza is cool enough to be handled, the practitioner may slice the pizza into pieces and serve the pizza pieces, as desired.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. A gluten-free cauliflower-based pizza dough for creating a cauliflower pizza crust, comprising:
a quantity of pureed cauliflower;
one or more dairy ingredients mixed with the quantity of pureed cauliflower to form a mixture;
one or more flour ingredients combined with the mixture;
one or more seasoning ingredients added to the mixture; and
one or more a thickening agent.

2. The pizza dough of claim 1, wherein the quantity of the pureed cauliflower comprises substantially 32.80%, by weight, of the pizza dough.

3. The pizza dough of claim 1, wherein the one or more dairy ingredients are comprised of egg whites and shredded mozzarella cheese, the egg whites comprising substantially 6.00% of the pizza dough and the shredded mozzarella cheese comprising substantially 22.20% of the pizza dough.

4. The pizza dough of claim 1, wherein the one or more dairy ingredients are comprised of egg whites, a portion of parmesan cheese, and a portion of mozzarella cheese.

5. The pizza dough of claim 1, wherein the one or more flour ingredients are comprised of potato flour, chickpea/garbanzo bean flour, brown rice flour.

6. The pizza dough of claim 5, wherein the pizza dough is comprised of substantially 15.80% potato flour, 11.60% chickpea/garbanzo bean flour, and 11.27% brown rice flour.

7. The pizza dough of claim 5, wherein the brown rice flour may be omitted, such that the pizza dough is grain-free and is comprised of 15.80% potato flour and 22.89% chickpea/garbanzo bean flour.

8. The pizza dough of claim 1, wherein the one or more seasoning ingredients are comprised of a quantity of Italian seasoning, the quantity comprising substantially 0.13%, by weight, of the pizza dough.

9. The pizza dough of claim 8, wherein the Italian seasoning comprises at least any of roasted garlic, basil, oregano, rosemary, and thyme.

10. The pizza dough of claim 1, wherein the one or more thickening agents comprises a quantity of xanthan gum and a portion of water to add texture to the pizza dough, the quantity comprising substantially 0.20%, by weight, of the pizza dough.

11. A preparation process for a cauliflower-based pizza crust, comprising:
obtaining a quantity of pureed cauliflower;
mixing one or more dairy ingredients with the quantity of pureed cauliflower to form a mixture;
combining flour ingredients with the mixture;
adding seasoning ingredients to the mixture;
incorporating a thickening agent into the mixture to form a pizza dough;
portioning the pizza dough into a plurality of portions;
flattening each of the plurality of portions to form a sheet portion and a crust portion; and
parbaking the plurality of portions.

12. The preparation process of claim 11, wherein obtaining the pureed cauliflower comprises combining cauliflower with water or chicken stock, cooking until the cauliflower is very tender, and pureeing by way of a slotted spoon or a food processor.

13. The preparation process of claim 11, wherein the quantity of pureed cauliflower comprises substantially 32.80% of the pizza dough.

14. The preparation process of claim 11, wherein the one or more dairy ingredients are comprised of egg whites and shredded mozzarella cheese.

15. The preparation process of claim 14, wherein parmesan cheese is used in place of a portion, or all the shredded mozzarella cheese.

16. The preparation process of claim 14, wherein the egg whites and the shredded mozzarella cheese respectively comprise 6.00% and 22.20% of the pizza dough.

17. The preparation process of claim 1, wherein the flour ingredients are comprised of potato flour, chickpea/garbanzo bean flour, and brown rice flour, the potato flour comprising substantially 15.80% of the pizza dough, the chickpea/garbanzo bean flour comprising substantially 11.60% of the pizza dough, and the brown rice flour comprising substantially 11.27% of the pizza dough.

18. The preparation process of claim 11, wherein the flour ingredients are comprised of potato flour and chickpea/garbanzo bean flour, the potato flour comprising substantially 15.80% of the pizza dough, the chickpea/garbanzo bean flour comprising substantially 22.89% of the pizza dough.

19. The preparation process of claim 11, wherein the seasoning ingredients comprise substantially 0.13%, by weight, of the pizza dough.

20. The preparation process of claim 19, wherein the seasoning ingredients are comprised of Italian seasoning.

21. The preparation process of claim 11, wherein the thickening agent is comprised of a quantity of xanthan gum, the quantity being substantially 0.20%, by weight, of the pizza dough.
